(19) United States
(12) Patent Application Publication
(10) Pub. No.: US 2024/0047759 A1
(43) Pub. Date: Feb. 8, 2024

(54) DIVERSE ELECTRODE CELL FOR ADJUSTABLE CURRENT DISTRIBUTION

(71) Applicant: FORD GLOBAL TECHNOLOGIES, LLC, Dearborn, MI (US)

(72) Inventors: Daewon Han, New Hudson, MI (US); Kyungjin Park, Canton, MI (US); Chi Paik, Grosse Ile, MI (US)

(21) Appl. No.: 17/880,263

(22) Filed: Aug. 3, 2022

(51) Int. Cl. H01M 10/0585; H01M 50/102; H01M 50/204; H01M 10/0525; H01M 10/04; B60L 50/64; H01M 10/42

(52) U.S. Cl. CPC H01M 10/0585; H01M 50/102; H01M 50/204; H01M 10/0525; H01M 10/0413; B60L 50/64; H01M 10/4214; H01M 2220/20

(57) ABSTRACT

Electrochemical stacks such as lithium-ion battery stacks and methods of assembling the same are disclosed. The stacks may include various electrochemical cells having different attributes. In one variation, the outer electrochemical cells may be different than the inner electrochemical cells. For example, the electrodes of the outer cells and inner cells may have different compositions, loading levels, and/or thicknesses. In a refinement, the separators of the outer cells and inner cells may have different thicknesses or porosities.

### TECHNICAL FIELD

The instant disclosure relates to electrochemical cell stacks such as lithium-ion batteries and more specifically, stacks having various different electrochemical cells.

### BACKGROUND

Electrochemical cells such as batteries are a primary method of storing energy. For example, many devices including electric vehicles (EVs) and hybrid electric vehicles (HEVs) may use batteries such as lithium-ion batteries. The high energy demands of these applications are met by larger stacks having more and thicker electrodes.

### SUMMARY

An electrochemical cell stack having an inner electrochemical cell and outer electrochemical cell is disclosed. The inner cell may include a first plurality of electrodes, a first electrolyte in contact with the first plurality of electrodes, and a first separator between the first plurality of electrodes. The outer cell may include a second plurality of electrodes, a second electrolyte in contact with the second plurality of electrodes and a second separator between the second plurality of electrodes. At least one of the first plurality of electrodes may have a different composition than a corresponding electrode of the second plurality of electrodes. For example, a cathode of the first plurality of electrodes may have a different composition than a cathode of the second plurality of electrodes and/or an anode of the first plurality of electrodes may have a different composition than an anode of the second plurality of electrodes. Alternatively, or in combination, at least one of the first plurality of electrodes may have a different loading than the corresponding electrode of the second plurality of electrodes. Alternatively, or in combination, at least one of the first plurality of electrodes has a different thickness than the corresponding electrode of the second plurality of electrodes. Alternatively, or in combination, the first separator may have a different thickness than the second separator. Alternatively, or in combination, the first separator may have a different porosity than the second separator. Said differently, any of the above differences may be exist alone or in various combinations with the other differences.

The different composition electrodes may allow for a non-uniform current distribution within the electrochemical cell stack. In a variation, each of the electrodes of the first plurality of electrodes may have a thinner thickness than a corresponding electrode in the second plurality of electrodes. In one or more embodiments, the first plurality of electrodes may include a cathode and an anode each having a thickness of 50 to 150 microns, or more preferably 80 to 120 microns, or even more preferably 90 to 110 microns. In a variation, the first plurality of electrodes each have a lower loading than each corresponding electrode of the second plurality of electrodes. For example, the loading of each of the first plurality of electrodes may be 1 to 20% lower than each corresponding electrode of the second plurality of electrodes. In a refinement, the cathode may have a loading of 10 to 40 mg/cm² and the anode may have a loading of 5 to 30 mg/cm². The electrochemical cells may be a lithium-ion batteries.

A vehicle comprising a power system having the electrochemical cell stack as disclosed herein is also provided.

A lithium-ion battery stack having at least first and second cells is also disclosed. The first cell may include a first cathode, a first anode, a first electrolyte in contact with the first cathode and the first anode, and a first separator disposed between the first cathode and the first anode. The second cell may include a second cathode, a second anode, a second electrolyte in contact with the second cathode and the second anode, and a second separator disposed between the second cathode and the second anode. The first and second cells may be different or not the same. For example, the first cathode may have a different composition, loading, and/or thickness than the second cathode. Alternatively, or in combination, the first anode may have a different composition, loading, and/or thickness than the second anode. Alternatively, or in combination, the first separator may have a different thickness and/or porosity than the second separator.

For example, the second separator may have a thickness that is 1 to 10% less (i.e., thinner) than the first separator. In one or more embodiments, the first separator may have a thickness of 3 to 20 microns. In a variation, the second separator may have a porosity that is 1 to 10% less than the first separator.

An electrochemical stack having a plurality of electrochemical cells is also disclosed. The stack may be a layered assembly. The stack may include a first electrochemical cell and a second electrochemical cell. The first electrochemical cell may have a first cathode layer, a first anode layer, a first electrolyte layer, and a first separator layer. The first electrolyte layer and first separator layer being disposed between the first cathode layer and the first anode layer. The second electrochemical cell may have a second cathode layer, a second anode layer, a second electrolyte layer, and a second separator layer. The second electrolyte layer and the second separator layer being disposed between the second cathode layer and the second anode layer. The first and second cathode layers, the first and second anode layers, and/or the first and second anode layer may be different.

The plurality of electrochemical cells may also include a third electrochemical cell. The third electrochemical cell may having a third cathode layer, a third anode layer, a third electrolyte layer, and a third separator layer. The third electrolyte layer and the third separator layer may be disposed between the third cathode layer and the third anode layer. The second electrochemical cell may be disposed between the first and third electrochemical cells. The first and third electrochemical cells may be the same, but the second electrochemical cell may be different. In a variation, the plurality of electrochemical cells may include up to 50 electrochemical cells.

### BRIEF DESCRIPTION OF THE DRAWINGS

FIG. 1 is a power system including an electrochemical cell stack such as for a vehicle.

FIG. 2 is a schematic view of an electrochemical cell stack.

FIG. 3 is a schematic view of an electrochemical cell forming a gradient.

FIG. 4 is flowchart illustrating steps for assembling the stacks described herein.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. A description of constituents in chemical terms refers to the constituents at the time of addition to any combination specified in the description and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

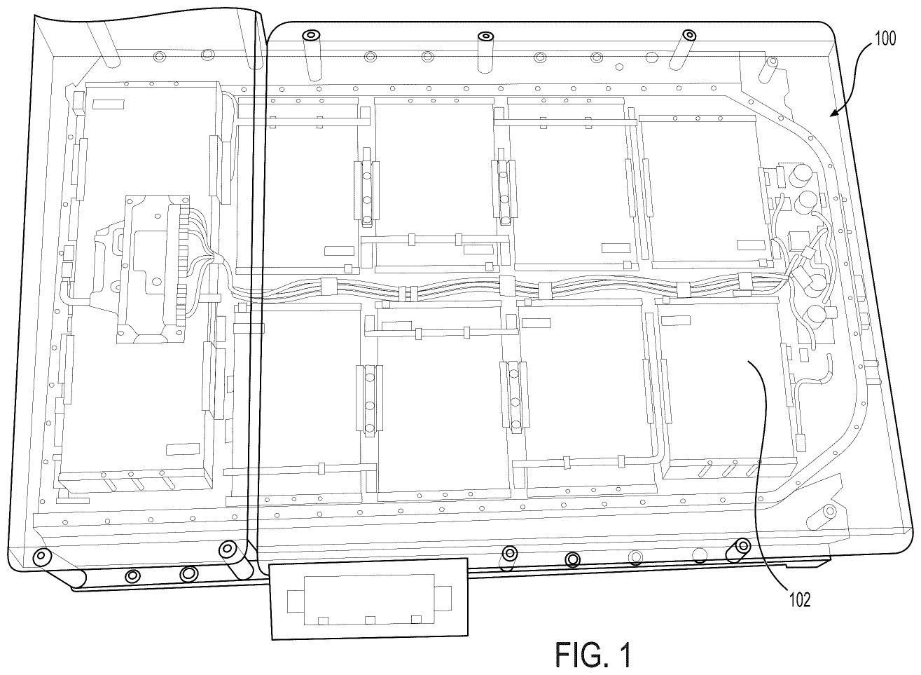

Electrochemical cells are often arranged together to in a stack 102, as shown in FIG. 1, to provide greater power and meet higher energy demands. For example, fuel cell stacks and/or battery stacks may be assembled with 2-100 cells, or more preferably 5-50 cells, or even more preferably 10-cells.

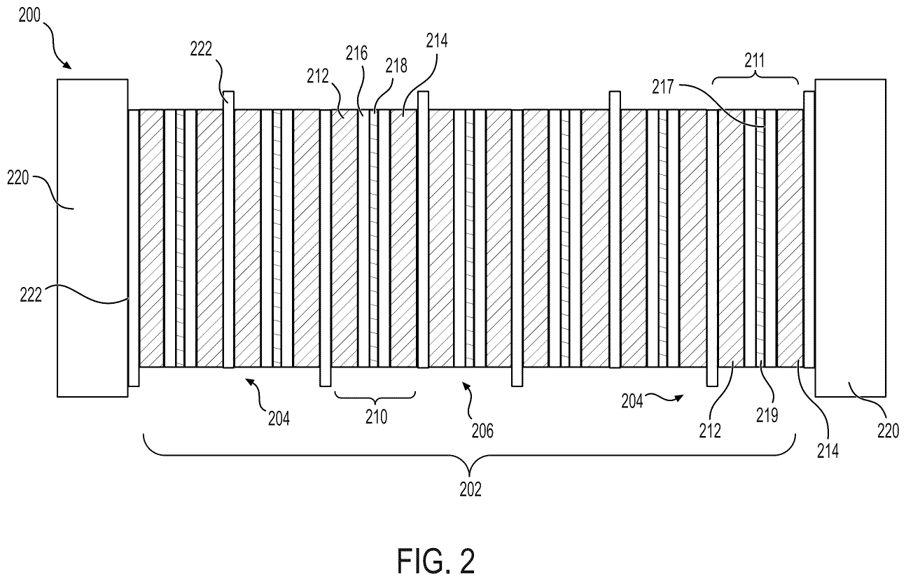

Referring to FIG. 2, each stack 200 may include a plurality of electrochemical cells 202 with outer cells 204 and inner cells 206. Each cell 210 may include a plurality of electrode such as a cathode 212, an anode 214, an electrolyte 216 in contact with and disposed between the cathode 212 and anode 214, and a separator 218 disposed between the cathode 212 and anode 214. The stack 200 may also include end plates 220 and/or current collectors 222. In a refinement, the stack 200 may be arranged as layers (i.e., a layered assembly).

Stack assemblies, and more specifically, large stack assemblies are especially common with high energy density and powerful electrochemical cells such as lithium-ion batteries which are often used in energy intensive devices. For example, the stack 102 may be incorporated into power system 100, as shown in FIG. 1. The power system may be used in a vehicle such as electric vehicles (EVs) and/or hybrid electric vehicle (HEVs). Often these energy intensive devices require large stacks which presents unique difficulties. For example, lithium-ion battery stacks, conventionally, require a uniform current distribution throughout the stack because identical electrochemical cells are used throughout stack. But cells at different areas, portions, regions, segments, or locations of the stack usually experience different operating conditions making uniformity difficult.

For example, the temperature and pressure may be different for different cells in different portions, regions, segments, or locations of the stack. Accordingly, it's not uncommon for the inner cells to experience a greater temperature during operation which leads to greater ion mobility and a non-uniform reaction rate. Varying temperatures can also lead to different expansion volumes which can contribute to different pressures applied to the outer and inner cells. Similarly, cell swelling can lead to exposure of different pressures between the inner and outer cells of a stack which can likewise effect operations.

However, non-uniform current distribution may be possible if electrochemical cells having different attributes are used for different portions, regions, segments or locations. For example, the cells may have different compositions, different loading levels, packing densities, and/or different thicknesses to accommodate the different operating conditions experienced during operation.

For example, the plurality of electrochemical cells 202 may include a first electrochemical cell 210 and a second electrochemical cell 211 that are different (i.e., have different attributes)/not the same/not identical. In a variation, the first cell 210 may have an electrode that is different than a corresponding electrode of the second cell 211. In a refinement, the first cell 210 may have an electrode with a different loading level than the second cell 211. In yet another example, the first cell 210 may have an electrode with a different packing density, thickness, volume, mass, and/or surface area than the second cell 211. Still further, the first cell 210 may have a first cathode 212 that has a different composition than a second cathode 213 of the second cell 211 and/or the first cell 210 may have a first anode 214 that has a different composition than a second anode 215 of the second cell 211.

Alternatively, or in combination, the first cell 210 may have an electrolyte 216 and/or separator 218 that is different from the electrolyte 217 and/or separator 219 of the second cell 211. In a refinement, the separator 218 of the first cell 210 may have a different thickness and/or porosity than the separator 219 of the second cell 211.

In one or more embodiments, one or more electrodes of the first cell 210 may have a greater or lesser loading level, packing density, and/or thickness than the corresponding electrode(s) in the second cell 211.

For example, one or more electrodes of the first cell 210 may have a lesser/lower loading level, packing density, and/or thickness than the corresponding electrode(s) in the second cell 211 (i.e., one or more of the electrodes of the second cell 211 may have a greater loading level, packing density, and/or thickness than corresponding electrode(s) of the first cell 210). Alternatively, one or more of electrodes of the first cell 210 may a greater loading level, packing density, and/or thickness than the corresponding electrode(s) in the second cell 211 (i.e., one or more of the electrodes of the second cell 211 may have a less/lower loading level, packing density, and/or thickness than corresponding electrode(s) of the first cell 210). In a variation, the cathode loading of the first or second cells 210, 211 may be 1 to 100 mg/cm², or more preferably 5 to 75 mg/cm², or even more preferably 10 to 40 mg/cm² and the anode loading may be 0.5 to 80 mg/cm², or more preferably 2.5 to 50 mg/cm², or even more preferably 5 to 30 mg/cm².

In a refinement, one or more of the electrodes of the second cell 211 may have a loading, packing density, and/or thickness of 1 to 50% greater than the corresponding electrode(s) of the first cell 210, or more preferably 5 to 25%, or even more preferably 7.5 to 15%. For example, the cathode 213 and/or anode 215 of the second cell 211 may have a loading, packing density, and/or thickness that is 1 to 20% greater than the cathode 212 and/or anode 214 of the first cell 210.

In another refinement, one or more of the electrodes of the first cell 210 may have a loading, packing density, and/or thickness of 1 to 50% greater than the corresponding electrode(s) of the second cell 211, or more preferably 5 to 25%, or even more preferably 7.5 to 15%. For example, the cathode 212 and/or anode 214 of the first cell 210 may have a loading, packing density, and/or thickness that is 10% more than the cathode 213 and/or anode 215 of the second cell 211.

For example, the one or more electrodes (e.g., plurality of electrodes) of the first cell 210 may include a cathode and/or an anode each having a thickness of 50 to 150 microns, or more preferably 80 to 120 microns, or even more preferably 90 to 110 microns.

In a refinement, the packing density of the first plurality of electrodes may be less than the packing density of second plurality of electrodes. For example, the packing density for the cathodes of the first plurality of electrodes may be 1 to 5, or more preferably 2 to 4, or even more preferably 2.5 to 3.7 g/cm 3 and for the anode of the first plurality of electrodes may be 0.5 to 4, or more preferably 1 to 2, or even more preferably 1.2 to 1.7 g/cm 3 after calendaring.

In one or more embodiments, the first cell 210 may one or more electrodes and/or a separator 218 that is thinner (i.e., less thick) than the corresponding electrode(s) and/or separator 219 of the second cell 211. For example, the thickness may be at least 2.5% less, or more preferably at least 5% less, or even more preferably at least 10% less. In a refinement, the thickness may be 1 to 50% less, or more preferably 5 to 25% less, or even more preferably 7.5 to 15% less.

Alternatively, the first cell 210 may one or more electrodes and/or a separator 218 that is thicker (i.e., greater) than the corresponding electrode(s) and/or separator 219 of the second cell 211. For example, the thickness may be at least 2.5% more, or more preferably at least 5% more, or even more preferably at least 10% more. In a refinement, the thickness may be 1 to 50% more, or more preferably 5 to 25% more, or even more preferably 7.5 to 15% more. For example, the thickness may be 1 to 10% thicker.

In one or more embodiments, the separators of the first or second cells 210, 211 may be 1 to 50 microns, or more preferably at least 2 to 40 microns, or even more preferably 3 to 20 microns.

In a refinement, the separator 219 of the second cell 211 may have a higher or lower porosity than the porosity of the separator 218 of the first cell 210. For example, the porosity may be at least 2.5% less, or more preferably at least 5% less, or even more preferably at least 10% less. In a refinement, the porosity may be 1 to 50% less, or more preferably 5 to 40% less, or even more preferably 7.5 to 25% less. For example, the porosity may be 1 to 10% less.

Alternatively, the porosity may be at least 2.5% more, or more preferably at least 5% more, or even more preferably at least 10% more. In a refinement, the porosity may be 1 to 50% more, or more preferably 5 to 25% more, or even more preferably 7.5 to 15% more. For example, the porosity may be 1 to 10% more.

In one or more embodiments, the porosity of the separator of the first or second cells 210, 211 may be 1 to 50%, or more preferably 5 to 40%, or even more preferably 10 to 30% according to ASTM D2873. In a refinement, the porosity may be calculated based on the packing density, loading, and electrode thickness. In still an alternative embodiment, the porosity may be determined with porosimetry.

In one or more embodiment, the first cell 210 may include a ceramic layer that is 0.25% to 30%, or more preferably 0.5% to 20%, or even more preferably 1 to 10% thicker or thinner than the corresponding ceramic layer of the second cell 211. In a variation, the ceramic layer of the first cell 210 may be 1 to 80 microns, or more preferably 5 to 50 microns, or even more preferably 10 to 30 microns. The ceramic layer may be, for example, aluminum oxide or any material other suitable inactive barrier layer for protecting the separator. In one or more embodiments, the ceramic layer of the second cell 211 may be 0.5 to 10 microns, or more preferably 1 to 8, or even more preferably 2 to microns.

In a variation, the first cell 210 may be an inner cell and the second cell 211 may be an outer cell or vice versa. In one variation, the inner cells 206 may be configured to accommodate a higher operating temperature/greater operating pressure such as by having thinner electrodes, a lower loading levels, thicker separators, and/or less porous separators than the outer cells 204 (i.e., the outer cells 204 may be configured to accommodate a lower operating temperature/lower operating pressure by having thicker electrodes, greater loading levels, thinner separators or more porous separators than the inner cells 206).

The plurality of cells 202 in the electrochemical stack 200 (e.g., lithium-ion battery stack) may also include a third electrochemical cell that is different than the first and/or second electrochemical cell. In a refinement, the third electrochemical cell may be the same or different than the first electrochemical cell. In yet another refinement, the third electrochemical cell may be the same or different than the second electrochemical cell. The third electrochemical cell may be another inner cell or another outer cell. The same may indicate that the electrochemical cells have cathodes having the same composition and anodes having the same composition with the same loading levels and thicknesses. The separators and electrolytes may also be the same. For example, the separators may be of the same thickness and porosity. The same as used herein means within manufacturing tolerances.

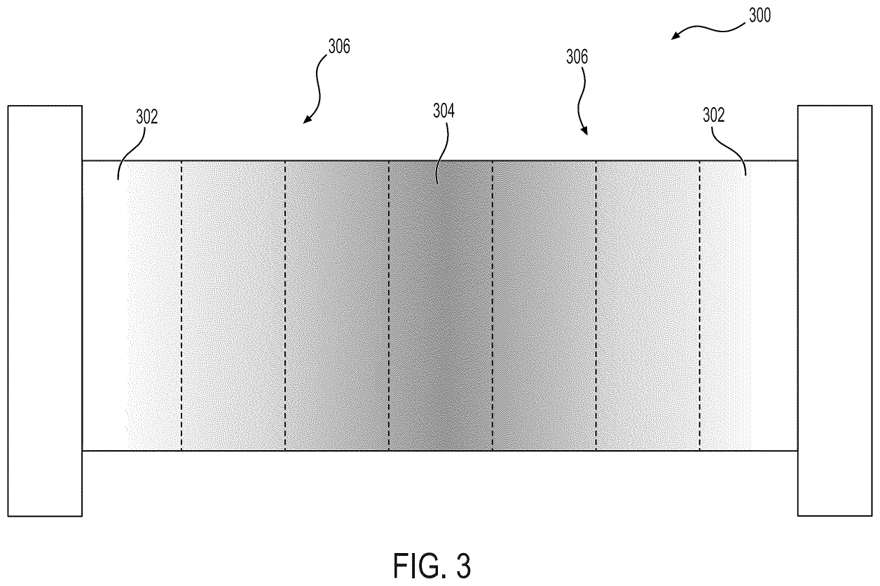

In one variation, the electrochemical cells of stack 300 may form a gradient, as shown in FIG. 3 with shading, such that the outer most cells 302 may be configured for the lowest operating temperature and/or pressure while the inner most cell(s) 304 are configured for the greatest operating temperature and/or pressure with the cells therebetween 306 being configured for temperatures therebetween. The cells may be configured in this manner by changing any single parameter or a combination or parameters that affect operation such as those described herein (e.g., composition, loading, packing density, thickness, and/or porosity).

For example, the outer most cells 302 may have the greatest electrode loading, and the inner most cell(s) 304 may have the lower loading levels, while the cells therebetween 306 have incrementally decreasing loading levels as they become more distant from the outer most cell and more proximate to the inner most cell. In yet another example, the outer most cells 302 may have the thinnest separators, and the inner most cell(s) 304 may have the thickest separators, while the cells therebetween 306 have incrementally decreasing thicknesses for the separator as they become more distant from the outer most cell and more proximate to the inner most cell. It should be understood that the same applies to any of the attributes or characteristics affecting operation of the cells such as those described herein.

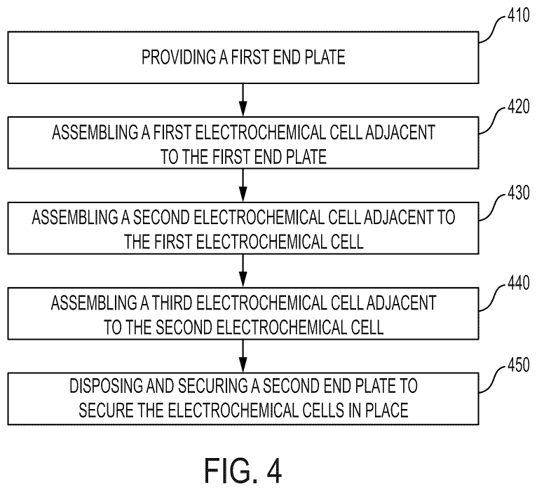

Methods of making the stacks disclosed herein are also disclosed. For example, a stack may be assembled by providing a first end plate (i.e., step 410), assembling a first electrochemical cell (i.e., step 420) adjacent to the first endplate, assembling a second electrochemical cell (i.e., step 430) adjacent to the first electrochemical cell, as shown in FIG. 4. The method may further include assembling a third electrochemical cell (i.e., step 440) adjacent to a second electrochemical cell and so on (e.g., a fourth electrochemical cell, a fifth electrochemical cell, a sixth electrochemical cell, etc.). Up to 100 electrochemical cell may be assembly, or more preferably up to 50 or even more preferably up to 20. For example, 10 electrochemical cells may be assembled. After a plurality of electrochemical cells are assembly together and adjacent to one another a second endplate may be disposed at a second end and secured to hold the electrochemical cells in place (i.e., step 450). Current collectors may also be disposed adjacent to or between the various electrochemical cells.

As described herein the electrochemical cells may be different. For example, the inner and outer cells may be different.

Each cell may be assembled by providing a cathode and an anode, contacting them with an electrolyte and disposing a separator between the cathode and anode. The electrodes may be formed by providing a substrate applying an electrode material including a catalyst to the substrate. In a refinement, separate solid and/or polymer electrolyte layers may be provided or applied directly to the electrode layers.

In a refinement, the stack may be a layered assembly such that it includes a cathode layer and an anode layer. The layered assembly may further include a separator disposed between the cathode and anode layer such that they do not contact each other. Electrolyte such as electrolyte layers may be disposed on each side of the separator and in contact with each of the electrode layers.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electrochemical cell stack comprising:
an inner cell having a first plurality of electrodes, a first electrolyte in contact with the first plurality of electrodes, and a first separator between the first plurality of electrodes; and
an outer cell having a second plurality of electrodes, a second electrolyte in contact with the second plurality of electrodes, and a second separator between the second plurality of electrodes, wherein (i) at least one of the first plurality of electrodes has a different composition than a corresponding electrode of the second plurality of electrodes, (ii) at least one of the first plurality of electrodes has a different loading than the corresponding electrode of the second plurality of electrodes, (iii) at least one of the first plurality of electrodes has a different thickness than the corresponding electrode of the second plurality of electrodes, (iv) the first separator has a different thickness than the second separator, (v) the first separator has a different porosity than the second separator, or (vi) a combination thereof.

2. The electrochemical cell stack of claim 1, wherein at least one of the first plurality of electrodes has a different composition than the corresponding electrode of the second plurality of electrodes.

3. The electrochemical cell stack of claim 2, wherein the different composition provides a non-uniform current distribution.

4. The electrochemical cell stack of claim 1, wherein at least one electrode of the first plurality of electrodes has a different thickness than at least one of the second plurality of electrodes.

5. The electrochemical cell stack of claim 4, wherein the first plurality of electrodes each have a thinner thickness than the second plurality of electrodes.

6. The electrochemical cell stack of claim 5, wherein the first plurality of electrodes includes a cathode with a cathode thickness of 50 to 150 microns and an anode with an anode thickness of 50 to 150 microns.

7. The electrochemical cell stack of claim 1, wherein at least one of the first plurality of electrodes has a different loading than at least one of the second plurality of electrodes.

8. The electrochemical cell stack of claim 7, wherein the first plurality of electrodes each have a lower loading than each corresponding electrode of the second plurality of electrodes.

9. The electrochemical cell stack of claim 8, wherein a loading of each of the first plurality of electrodes is 1 to 20% lower than each corresponding electrode of the second plurality of electrodes.

10. The electrochemical cell stack of claim 9, wherein the first plurality of electrodes has a cathode loading of 10 to 40 mg/cm² and an anode loading of 5 to 30 mg/cm².

11. The electrochemical cell stack of claim 1, wherein the cells are a lithium-ion battery cells.

12. A vehicle comprising a power system having the electrochemical cell stack of claim 1.

13. A lithium-ion battery stack comprising:
a first cell having a first cathode, a first anode, a first electrolyte in contact with the first cathode and the first anode, and a first separator disposed between the first cathode and the first anode; and
a second cell having a second cathode, a second anode, a second electrolyte in contact with the second cathode and the second anode, and a second separator disposed between the second cathode and the second anode, wherein the first and second cells are not same.

14. The lithium-ion battery stack of claim 13, wherein (i) the first cathode has a different composition, loading, and/or thickness than the second cathode, (ii) the first anode has a different composition and/or loading than the second anode, and/or (iii) the first separator has a different thickness and/or porosity than the second separator.

15. The lithium-ion battery stack of claim 14, wherein the second separator has a thickness that is 1-10% thinner than the first separator.

16. The lithium-ion battery stack of claim 15, wherein the first separator has a thickness of 3 to 20 microns.

17. The lithium-ion battery stack of claim 13, wherein the second separator has a porosity that is 1-10% less than the first separator.

18. An electrochemical stack comprising:
a plurality of electrochemical cells including a first electrochemical cell having a first cathode layer, a first anode layer, a first electrolyte layer disposed between the first cathode layer and the first anode layer, a first separator layer disposed between the first cathode layer and the first anode layer, and a second electrochemical cell having a second cathode layer, a second anode layer, a second electrolyte layer disposed between the second cathode layer and the second anode layer, and a second separator layer disposed between the second cathode layer and the second anode layer, wherein the first and second cathode layers are different, the first and second anode layers are different, and/or the first and second separator layers are different.

19. The electrochemical stack of claim 18, wherein the plurality of electrochemical cells includes a third electrochemical cell having a third cathode layer, a third anode layer, a third electrolyte layer disposed between the third cathode layer and the third anode layer, and a third separator layer disposed between the third cathode layer and the third anode layer, wherein the second electrochemical cell is disposed between the first electrochemical cell and the third electrochemical cell, and wherein the first and third electrochemical cells are same and the second electrochemical cell is different than the first and third electrochemical cells.

20. The electrochemical stack of claim 19, wherein the plurality of electrochemical cells includes up to 50 electrochemical cells.
